(19) United States
(12) Patent Application Publication
(10) Pub. No.: US 2006/0001742 A1
(43) Pub. Date: Jan. 5, 2006

(54) System keyboard and remotely controlled surveillance system using the system keyboard

(75) Inventor: Sang-hoon Park, Hwaseong-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/172,998

(22) Filed: Jul. 5, 2005

(30) Foreign Application Priority Data
Jul. 5, 2004 (KR) 10-2004-0052009

(51) Int. Cl. H04N 7/18

(52) U.S. Cl. 348/143; 340/506; 382/239; 341/22

(57) ABSTRACT

A system keyboard having a snapshot function and a surveillance system using the system keyboard are provided. The system keyboard includes a video port, which receives a video signal, a user interface unit, which receives a command from a user, a control unit, which generates a control signal based on the received command, a serial communication port, which transmits the control signal to at least one of a plurality of components of the surveillance system, and a storage unit, which stores at least part of the received video signal in response to the control signal.

### CROSS-REFERENCE TO RELATED APPLICATION

This application claims benefit from Korean Patent Application No. 10-2004-0052009 filed on Jul. 5, 2004 in the Korean Intellectual Property Office, the disclosure of which is incorporated herein by reference in its entirety.

### BACKGROUND OF THE INVENTION

1. Field of the Invention

The present invention relates to a surveillance system, and more particularly, to a system keyboard having a snapshot function and a surveillance system using the system keyboard.

2. Description of the Related Art

Surveillance systems are also called closed circuit television (CCTV) systems. In general, while a TV broadcasting system transmits image data to unspecified individuals in a wireless manner, a CCTV system transmits image data to a specified individual in a wired or wireless manner.

Surveillance systems can be used for a wide variety of purposes, such as monitoring a remote location, an area away from human reach, an obscure area, or multiple areas at the same time. Surveillance systems can be installed in the parking lots of shopping malls or office buildings, outside residences, inside nuclear power plants, or in military bases. Surveillance systems can monitor multiple spots at the same time.

FIG. 1 is a block diagram of a conventional remotely controlled surveillance system.

Referring to FIG. 1, the conventional remotely controlled surveillance system largely consists of a camera system 110, a transmission system 120, and an image processing system 130, which are described in more detail below. The camera system 110 includes one or more cameras 112. The cameras 112 capture a plurality of images of a target region that the conventional remotely controlled surveillance system is expected to surveil. The cameras 112 may be charge-coupled device (CCD)-type cameras, which are widely used in surveillance systems. However, the cameras 112 may be complementary metal-oxide semiconductor (CMOS)-type cameras.

The transmission system 120 transmits an image signal obtained by the camera system 110 to the image processing system 130. Even though the transmission system 120 can transmit the image signal to the image processing system 130 in a wired manner or in a wireless manner, it usually adopts a wired transmission method because a wireless transmission method requires the allocation of frequencies. Examples of the wired transmission method include a baseband transmission method, which transmits the image signal to the image processing system 130 keeping the image signal intact, a carrier wave transmission method, which modulates the image signal and transmits the modulated image signal to the image processing system 130 over a carrier wave, a pulse code modulation (PCM) transmission method, and an optical communication method, which modulates the image signal, i.e., an electrical signal, into an optical signal and transmits the optical signal to the image processing unit 130. These transmission methods have their own characteristics. Thus, the transmission system 120 selectively uses one of the transmission methods after considering the distance between the surveillance system and the target region, the purpose of usage and the manufacturing cost of the surveillance system. The transmission system 120 may also include a video distribution amplifier (VDA), which transmits the image signal obtained by the cameras 112 to a plurality of monitors and a plurality of videocassette recorders (VCR). In other words, the video distribution amplifier can be used for exercising surveillance over a plurality of places using the camera system 110. The image signal obtained by the camera system 110 is transmitted to a plurality of image processing systems by the video distribution amplifier. The transmission system 120 may use a serial communication method or a TCP/IP communication method to transmit a control signal.

The image processing system 130 receives the image signal transmitted by the transmission system 120 and reproduces, stores, or edits the received image signal. The image processing system 130 includes one or more monitors 132, one or more storage systems 134, and an image control unit 136. The storage systems 134 may be VCRs, which record image data obtained from the image signal received by the image processing system 130 on a magnetic tape. However, the storage systems 134 may be digital video recorders (DVRs), which compress and store image data using a digital compression method (e.g., MPEG), or decompresses and reproduces digitally compressed image data. The image control unit 136 includes a quad processor, a multiplexer, and a matrix. The quad processor receives four individual images, divides the screen of a monitor 132, and simultaneously displays the received images on the screen of the monitor 132. The multiplexer sequentially switches a plurality of images captured by a total of 8 or 16 cameras 112 so that the captured images can be stored in one storage system 134. The matrix displays a plurality of images on the screens of a plurality of monitors using a cross-point switching method.

The conventional remotely controlled surveillance system needs to be controlled by a user. A system keyboard 140, which is also called a keyboard or a system controller, is used to control the conventional remotely controlled surveillance system. The system keyboard 140 controls the cameras 112, the monitors 132, and other components of the conventional remotely controlled surveillance system. By using the system keyboard 140, the user can both designate locations needed to be watched over by the cameras 112 and adjust what the cameras 112 focus on. In addition, the system keyboard 140 can set preset locations using a preset function. Once the preset locations are set, the user can control the cameras 112 to watch over the preset locations by hitting a ‘preset’ button for each of the cameras 112. Moreover, by using a joystick of the system keyboard 140, the user can adjust the locations of the cameras 112 or the focal distances of the lenses (not shown) that are included in the cameras 112 or installed in the camera system 110 separately from the cameras 112.

As described above, the user can conveniently control the conventional remotely controlled surveillance system using the system keyboard 140. However, the system keyboard 140 does not include a storage system of its own. Since the system keyboard 140 does not provide a snapshot function, the user cannot take a snapshot of a specific event that occurs in the process of controlling the cameras 112. In addition, the system keyboard 140 cannot display images and thus cannot constitute a surveillance system alone. In other words, the system keyboard 140 always needs other devices, such as, the quad processor and the monitors 132, to constitute a surveillance system.

Therefore, for user convenience a system keyboard having a snapshot function or having both the snapshot function and a display function needs to be developed.

### SUMMARY OF THE INVENTION

Additional aspects and/or advantages of the invention will be set forth in part in the description which follows and, in part, will be apparent from the description, or may be learned by practice of the invention.

The present invention provides a system keyboard having a snapshot function.

The present invention also provides a system keyboard having a snapshot function and a display function.

The present invention also provides a surveillance system using a system keyboard having a snapshot function or having both the snapshot function and a display function.

The above stated objects as well as other objects, features and advantages, of the present invention will become clear to those skilled in the art upon review of the following description.

According to an aspect of the present invention, there is provided a system keyboard having a snapshot function, used in a surveillance system, the system keyboard including a video port, which receives a video signal, a user interface unit, which receives a command from a user, a control unit, which generates a control signal based on the received command, a serial communication port, which transmits the control signal to at least one of a plurality of components of the surveillance system, and a storage unit, which stores at least part of the received video signal in response to the control signal.

According to another aspect of the present invention, there is provided a surveillance system including a plurality of cameras, which receive optical signals and generates electrical signals based on the received optical signals, and a system keyboard, which controls the cameras using a serial communication method, receives a video signal from each of the cameras, and stores at least part of the received video signal at the request of a user.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional remotely controlled surveillance system;

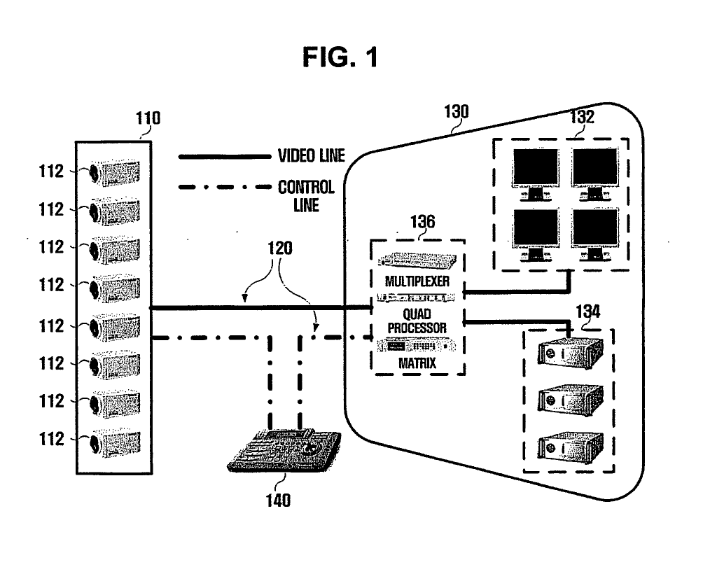

FIG. 2 is a lock diagram of a remotely controlled surveillance system according to an exemplary embodiment of the present invention;

FIG. 3 is a detailed block diagram of a system keyboard according to an exemplary embodiment of the present invention;

FIG. 4 is a detailed block diagram of a system keyboard according to another exemplary embodiment of the present invention; and

FIG. 5 is a detailed block diagram of a system keyboard according to still another exemplary embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which preferred embodiments of the invention are shown.

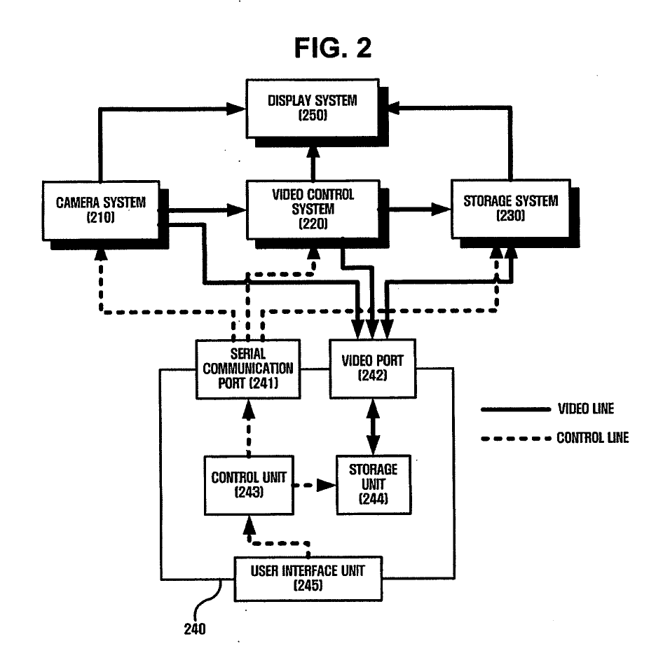

FIG. 2 is a block diagram of a remotely controlled surveillance system according to an embodiment of the present invention.

Referring to FIG. 2, the remotely controlled surveillance system includes a camera system 210 and at least one system keyboard 240, which controls the camera system 210. The remotely controlled surveillance system may include a plurality of system keyboards when it needs to watch over one or more persons or places. However, the remotely controlled surveillance system will now be described as having only one system keyboard.

The camera system 210 includes at least one camera, which receives an optical signal and generates an electrical signal based on the received optical signal. The camera system 210 may be controlled using a control signal sent by the system keyboard 240. For example, a user may change the location or direction of the camera or may control the camera to zoom in or out by using the system keyboard 240.

In order to change the direction of the camera, the camera system 210 must include a camera driving device, such as a pan and tilt device. In order to provide a zoom function, the camera system 210 must include a lens having a focus adjustment function. Surveillance systems generally do not include lenses, but special cameras do. However, the camera system 210 does not need to be controlled by the system keyboard 240. For example, when the remotely controlled surveillance system is designed with the location and direction of the cameras fixed, there is no need to control the camera system 210 using the system keyboard 240.

The system keyboard 240 also controls other components of the remotely controlled surveillance system. According to an aspect of the present invention, the system keyboard 240 includes a user interface unit 245, which receives a command from the user, a control unit 243, which generates a control signal based on the received command, and a serial communication port 241, which transmits the control signal to each of the components of the remotely controlled surveillance system. The system keyboard 240 includes a video port 242, which receives or outputs a video signal, and a storage unit 244, which stores at least part of a video signal input to the system keyboard 240 via the video port 242.

The storage unit 244 can store still images or moving images. If the user takes a snapshot a portion of a video signal input to the system keyboard 240 in real time from the camera system 210 or a video control system 220 via the user interface unit 245, the storage unit 244 stores the snapshot. The user can also take a snapshot of video data stored in a storage system 230 in the process of reproducing the video data. The user interface unit 245 may include a snapshot button. Accordingly, if the user pushes the snapshot button while watching video data being reproduced, a portion of the video data is snapshot as a still image and then is stored in the storage unit 244. The storage unit 244 has been described above as storing a still image as a result of taking a snapshot of a video signal. However, the storage unit 244 can also store a moving image. For example, if the user keeps the snapshot button pressed for a predetermined amount of time, a moving image comprised of a plurality of still images is captured and then stored in the storage unit 244. In short, a snapshot image stored in the storage unit 244 will now be described as being a still image even though it could be a moving image.

The system keyboard 240 may also include a display unit (not shown), in which case, the camera system 210 and the system keyboard 240 can constitute a complete surveillance system by themselves. However, if the system keyboard 240 does not include a display unit of its own, the remotely controlled surveillance system preferably, but not necessarily, includes a display system 250. In a case where the system keyboard 240 includes a display unit of its own, the user interface unit 245 may be an on-screen display (OSD) device, in which case, the display unit may serve all or some of a plurality of functions of the user interface unit 245.

The display system 250 receives a real-time video signal from one or both of the camera system 210 and the video control system 220 and displays the received real-time video signal. In addition, the display system 250 receives a video signal stored in the storage system 230 and displays the received video signal. The display system 250 may output a snapshot image stored in the system keyboard 240. In order to output a snapshot image, the display system 250 must include at least one monitor. The monitor may be a liquid crystal display (LCD) monitor, a cathode ray tube (CRT) monitor, a plasma display panel (PDP), or an organic electroluminescence (EL) display. The monitor outputs a video signal or a still image. The user selects and takes a snapshot of a real-time video signal displayed by the display system 250.

The remotely controlled surveillance system may also include the storage system 230. The storage system 230 receives a real-time video signal from one or both of the camera system 210 and the video control system 220 and stores the received real-time video signal. The storage system 230 includes at least one storage system. The storage system may be a VCR, which receives and stores an analog video signal, a DVR, which receives and stores an analog video signal or a digital video signal, or another recording device. If the storage system is a DVR, the real-time video signal received by the storage system 230 may be digitally compressed using the MPEG-2, MPEG-4, H.263, H.264, MPEG-7, or MPEG-21 format and then stored in the storage system. The storage system 230 receives a control signal from the system keyboard 240 and a snapshot image and stores the image in the system keyboard 240 in response to the control signal.

The remotely controlled surveillance system may also include the video control system 220, which receives a video signal from the camera system 210 and determines portions of the video signal to be output to the display system 250, and other portions of the video signal to be stored in the storage system 230. The video control system 220 may include one or more video control devices, for example, a quad processor, a multiplexer, and a matrix. The video control systems may be used for controlling the components of the remotely controlled surveillance system in response to a control signal received from the system keyboard 240.

According to an aspect of the present invention, the structures of examples of the system keyboard 240 will now be described in further detail.

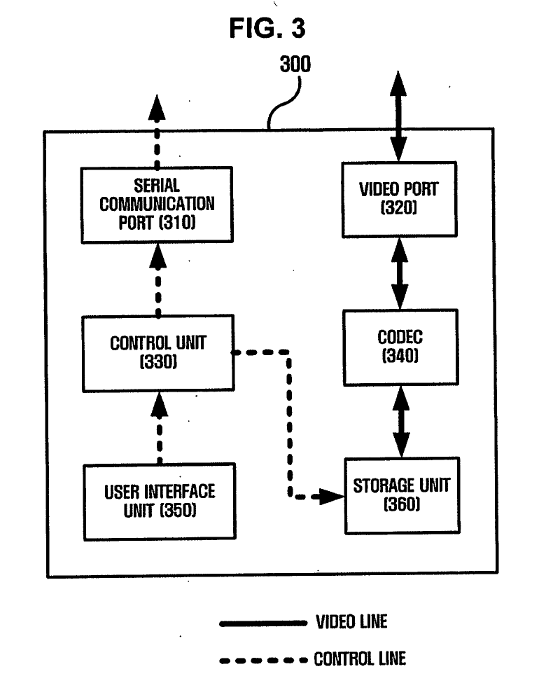

FIG. 3 is a detailed block diagram of a system keyboard 300 according to an exemplary embodiment of the present invention.

Referring to FIG. 3, the system keyboard 300 includes a user interface unit 350, which receives a command from a user, a control unit 330, which generates a control signal based on the received command, a serial communication port 310, which transmits the control signal to each of the components of the remotely controlled surveillance system of FIG. 2, a video port 320, which receives a video signal from the camera system 210, the video control system 220, or the storage system 230 of the remotely controlled surveillance system of FIG. 2 or transmits an image stored in a storage unit 360 to the storage system 230 or the display system 250 of the remotely controlled surveillance system of FIG. 2, the storage unit 360, which stores at least part of the video signal received via the video port 320, and a codec 340.

The serial communication port 310 uses a serial communication method, rather than a parallel communication method, to transmit a control signal to the remotely controlled surveillance system of FIG. 2 because the control signal, unlike a video signal, does not need to be transmitted at high speed and the serial communication method is very useful for communication between remote devices. The serial communication method is implemented in a simplified and cost-efficient manner.

The serial communication method can be synchronous or asynchronous. In the synchronous serial communication method, two devices that attempt to communicate with each other must be synchronized with each other at all times. In other words, the two devices must transmit data to each other in a synchronized manner. In order to synchronize the two devices, a control signal must be transmitted to each device at regular intervals. Once the two devices are synchronized, a signal indicating the starting point and the ending point of data to be transmitted between the devices is unnecessary and the two devices can transmit data to each other at high speed.

On the other hand, in the asynchronous serial communication method, two devices that attempt to communicate with each other do not need to be synchronized with each other. Accordingly, a control signal required for synchronizing the devices is unnecessary, but a signal indicating the starting point and the ending point of data to be transmitted between the two devices is necessary. According to an aspect of the present embodiment, the serial communication port 310 uses the asynchronous serial communication method.

Examples of the asynchronous serial communication method include RSC232C, RS423, RS422, and RS485. RS232C supports one driver and one receiver, a maximum communication distance of 15 m, a maximum communication speed of 20 Kbps, a full duplex mode, a maximum output voltage of −25-+25 V, and a maximum input voltage of −15-+15 V. RS423 supports one driver and 10 receivers, a maximum communication distance of 1.2 Km, a maximum communication speed of 100 Kbps, a full duplex mode, a maximum output voltage of −6-+6 V, and a maximum input voltage of −12-+12. RS422 supports one driver and 32 receivers, a maximum communication distance of 1.2 Km, a maximum communication speed of 10 Mbps, a full duplex mode, a maximum output voltage of −0.25-+6 V, and a maximum input voltage of −7-+7 V. RS485 supports 32 drivers and 32 receivers, a maximum communication distance of 1.2 Km, a maximum communication speed of 10 Mbps, a half duplex mode, a maximum output voltage of −7 V-+12 V, and a maximum input voltage of −7V-+12. Accordingly, RS232C is appropriate for a close range remotely controlled surveillance system. However, since the maximum communication distance supported by RS232C is relatively short, RS232C is not appropriate for a long range surveillance system. On the other hand, RS423, RS422, and RS485 support a relatively long maximum communication distance of 1.2 Km, and thus, can be used for long range surveillance systems. RS423 and RS422, however, support only one driver and a full duplex mode, and thus, require two transmission lines. Accordingly, the serial communication port 310 preferably, but not necessarily, uses RS485 rather than RS423 and RS422.

The functions and operations of the video port 320, the control unit 330, and the user interface unit 350 will be described in detail with reference to FIG. 2.

Referring to FIGS. 2 and 3, if a video signal input via the video port 320 is an uncompressed video signal, the storage unit 360 may store part of the video signal or an uncompressed still image. However, for efficient use of the storage unit 360, a compressed video signal or a compressed still image is stored in the storage unit 360. For this, the system keyboard 300 includes the codec 340. The codec 340 compresses the video signal input via the video port 320 using the MPEG-2, MPEG-4, H.263, H.264, MPEG-7, or MPEG-21 standard and then sends the compressed video signal to the storage unit 360. When a moving image stored in the storage unit 360 is output via the video port 320, the codec 340 decompresses the moving image using the MPEG-2, MPEG-4, H.263, H.264, MPEG-7, or MPEG-21 format and then provides the decompressed moving image to the video port 320. If a compressed video signal is inputted via the video port 320, the codec 340 is bypassed and the signal is stored in the storage unit 360.

When a snapshot still image is stored in the storage unit 360, the codec 340 compresses the snapshot still image using a still image compression method, such as a DCT-based JPEG or JPEG2000 wavelet-transformation, and provides the compressed snapshot still image to the storage unit 360. The storage unit 360 can be a volatile memory, such as DRAM or SRAM. However, the storage unit 360 can also be a non-volatile memory, such as a flash memory or a hard disc drive. When outputting the snapshot still image stored in the storage unit 360 via the video port 320, the codec 340 decompresses the snapshot still image using, for example, a JPEG or JPEG2000 decompression method, and provides the decompressed snapshot still image to the video port 320. In the present invention, an encoder that digitally compresses a video signal or a still image and a decoder that digitally decompresses the compressed video signal or the compressed still image are integrated into the codec 340. However, the encoder and the decoder can be separate from each other.

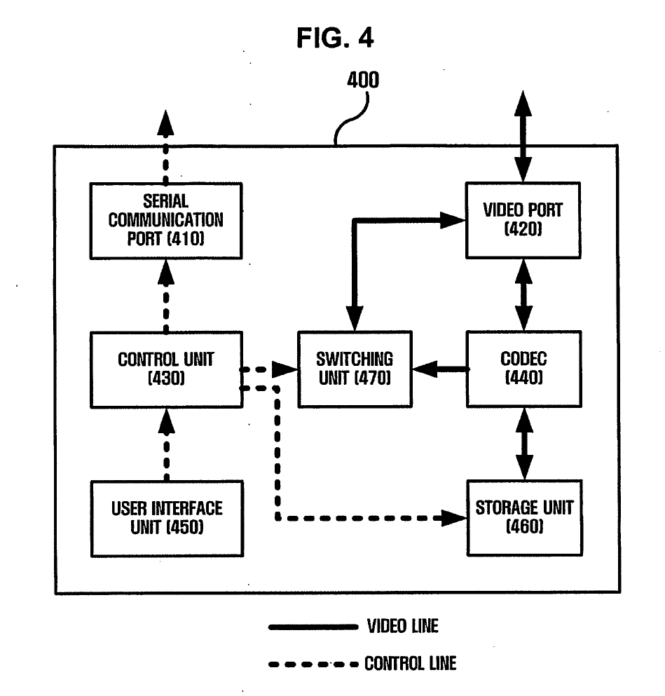

FIG. 4 is a detailed block diagram of a system keyboard 400 according to another exemplary embodiment of the present invention.

Referring to FIG. 4, the system keyboard 400 includes a user interface unit 450, which receives a command from a user, a control unit 430, which generates a control signal based on the received command, a serial communication port 410, which receives the control signal from the control unit 430 and transmits it to each of the components of the remotely controlled surveillance system of FIG. 2, a video port 420, which receives a video signal from the remotely controlled surveillance system of FIG. 2 (particularly, from the camera system 210, the video control system 220, or the storage system 230 of FIG. 2) or transmits a snapshot image stored in a storage unit 460 to the remotely controlled surveillance system of FIG. 2 (particularly, to the storage system 230 or the display system 250 of FIG. 2), the storage unit 460, which stores at least part of the video signal received by the video port 420, and a codec 440. The system keyboard 400, unlike the system keyboard 300 of FIG. 3, also includes a switching unit 470. The functions and operations of the serial communication port 410, the video port 420, the control unit 430, the codec 440, and the user interface unit 450 are the same as their equivalents in FIG. 3, and thus, their detailed descriptions have been omitted.

The switching unit 470 selects one or both of the video signals received from the remotely controlled surveillance system of FIG. 2 via the video port 420 and the snapshot image stored in the storage unit 460 in response to the control signal generated by the control unit 430. The video signal and the snapshot image selected by the switching unit 470 are output via the video port 420 when selected by the switching unit 470 and are then displayed by an external display system.

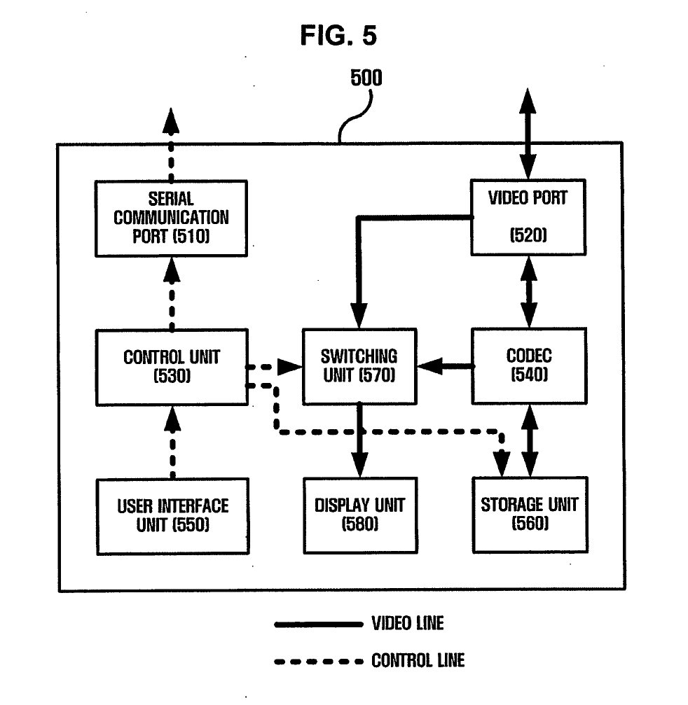

FIG. 5 is a detailed block diagram of a system keyboard 500 according to another embodiment of the present invention.

Referring to FIG. 5, the system keyboard 500 includes a user interface unit 550, which receives a command from a user, a control unit 530, which generates a control signal based on the received command, a serial communication port 510, which receives the control signal from the control unit 530 and transmits it to each of the components of the remotely controlled surveillance system of FIG. 2, a video port 520, which receives a video signal from the remotely controlled surveillance system of FIG. 2 (particularly, from the camera system 210, the video control system 220, or the storage system 230 of FIG. 2) or transmits a snapshot image stored in a storage unit 560 to the remotely controlled surveillance system of FIG. 2 (particularly, to storage system 230 or the display system 250 of FIG. 2), the storage unit 560, which stores at least part of the video signal received by the video port 420, a codec 440, and a switching unit 570. The system keyboard 500, unlike the system keyboard 400 of FIG. 4, also includes a display unit 580. The functions and operations of the serial communication port 510, the video port 520, the control unit 530, the codec 540, and the user interface unit 550 are the same as their equivalents in FIG. 3, and thus, their detailed descriptions have been omitted.

The switching unit 570 selects one or both of the video signals received from the remotely controlled surveillance system of FIG. 2 via the video port 420 and the snapshot image stored in the storage unit 460 in response to the control signal generated by the control unit 430. Then, the display unit 580 displays the video signal and/or the snapshot image selected by the switching unit 470.

The display unit 580 may be an LCD device, a CRT display system, an organic EL display system, or a PDP.

As described above, according to the present invention, a user can take a snapshot of a portion of a video signal input in real time from a camera or a video control system, such as a quad processor, a multiplexer, or a matrix, using the system keyboard, and the snapshot can be stored in a storage system.

In addition, the user can take a snapshot of a video signal previously stored in the storage system using the system keyboard, and the snapshot can be stored in the system keyboard.

Further, the snapshot can be stored in the storage system or it can be transmitted to other components of the surveillance system.

In conclusion, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

Although a few embodiments of the present invention have been shown and described, it would be appreciated by those skilled in the art that changes may be made in these embodiments without departing from the principles and spirit of the invention, the scope of which is defined in the claims and their equivalents

What is claimed is:

1. A system keyboard used in a system, comprising:
a video port, which receives a video signal;
a user interface unit, which receives a command;
a control unit, which generates a control signal based on the received command;
a communication port, which transmits the control signal; and
a storage unit, which stores at least part of the received video signal in response to the control signal.

2. The system keyboard of claim 1, wherein the at least part of the received video signal stored in the storage unit is a snapshot image of a portion of the video signal input.

3. The system keyboard of claim 1, wherein the user interface unit comprises a snapshot button, which enables the user to select a predetermined portion of the received video signal.

4. The system keyboard of claim 1 further comprising an encoder, which compresses the at least part of the received video signal,
wherein the at least part of the video signal stored in the storage unit in response to the control signal has been compressed by the encoder.

5. The system keyboard of claim 1 further comprising a switching unit, which selects one or both of the received video signals and the at least part of the received video signal stored in the storage unit in response to the control signal,
wherein one or both of the received video signal and the at least part of the received video signal selected by the switching unit are output to the video port.

6. The system keyboard of claim 1 further comprising:
a switching unit, which selects one or both of the received video signals and the at least part of the received video signal stored in the storage unit in response to the control signal; and
a display unit, which displays one or both of the received video signal and the at least part of the received video signal stored in the storage unit selected by the switching unit.

7. The system keyboard of claim 6, wherein the display unit is a liquid crystal display (LCD) device.

8. The system keyboard of claim 1, wherein the communication port is an RS485 communication port.

9. A surveillance system comprising:
a plurality of cameras, which receive optical signals and generate electrical signals based on the received optical signals; and
a system keyboard, which controls the cameras using a serial communication method, receives a video signal from each of the cameras, and stores at least part of the received video signal at the request of a user.

10. The surveillance system of claim 9 further comprising a storage system, which stores the video signal received from the camera.

11. The surveillance system of claim 10, wherein the storage system receives at least part of the video signal stored in the system keyboard in response to a control signal input thereto from the system keyboard and stores the at least part of the video signal.

12. The surveillance system of claim 10, wherein the storage system transmits the video signal stored in the storage system to the system keyboard in response to a control signal input thereto from the system keyboard using the serial communication method.

13. The surveillance system of claim 9, wherein the at least part of the received video signal stored in the system keyboard is a snapshot image of a predetermined portion of the received video signal.

14. The surveillance system of claim 12, wherein the serial communication method is an RS485 communication method.

15. The surveillance system of claim 9 further comprising a display system, which receives a video signal or a still image from at least one of the system keyboard and the camera and displays the video signal or the still image.

16. The surveillance system of claim 9, wherein the system keyboard comprises:
a video port, which receives a video signal;
a user interface unit, which receives a command from a user;
a control unit, which generates a control signal based on the received command;
a serial communication port, which transmits the control signal to at least one of a plurality of components of the surveillance system; and
a storage unit, which stores at least part of the received video signal in response to the control signal.

17. The surveillance system of claim 16, wherein the user interface unit comprises a snapshot button, which enables the user to select a predetermined portion of the received video signal and store the selected portion in the storage unit.

18. The surveillance system of claim 16, wherein the system keyboard further comprises an encoder, which compresses the at least part of the received video signal,
wherein the at least part of the received video signal stored in the storage unit in response to the control signal has been digitally compressed by the encoder.

19. The surveillance system of claim 16, wherein the system keyboard further comprises:
a switching unit, which selects one or both of the received video signals and the at least part of the received video signal stored in the storage unit in response to the control signal; and
a display unit, which displays one or both of the received video signal and the at least part of the received video signal selected by the switching unit.

20. A method of storing a snapshot image in a surveillance system, comprising:
checking a snapshot command; and
storing a snapshot image based up the snapshot command in a system keyboard.
